(19) United States
(12) Patent Application Publication
(10) Pub. No.: US 2022/0041007 A1
(43) Pub. Date: Feb. 10, 2022

(54) Braille Color-Indicating Writing Instruments

(71) Applicant: Christy K. Stanley, Albertville, AL (US)

(72) Inventor: Christy K. Stanley, Albertville, AL (US)

(21) Appl. No.: 16/986,580

(22) Filed: Aug. 6, 2020

(51) Int. Cl. B43K 29/00; G09B 21/00

(52) U.S. Cl. CPC B43K 29/00; G09B 21/003

(57) ABSTRACT

A writing instrument that has a tip for directly contacting and writing on a medium and a body contiguous with the tip, the body configured for grasping the writing instrument for writing on the medium. The writing instrument further has a first recess on a first side of the writing instrument, the first recess comprising a first braille color indicator comprising a first plurality of raised dots.

### BACKGROUND

Braille is a tactile reading and writing system used by blind and visually-impaired people who cannot access print materials, It uses raised dots to represent the letters of the print alphabet. Further, it uses symbols to represent punctuation, mathematics and scientific characters, music, computer notation and foreign languages. Braille is a code by which all languages may be written and read. Using braille, people who are blind can review and study the written word. It provides a vehicle for literacy and gives a blind or visually-impaired individual the ability to become familiar with spelling, punctuation, paragraphing, and other formatting considerations.

For children, many companies produce coloring books for the blind and visually-impaired children. The coloring books typically have raised-line tactile art drawings. The blind and visually-impaired children, through use of touch, can feel the drawings and decide what color(s), colored pencil(s), or colored marker(s) to use to fill in the different demarcations on the raised-line tactile art drawings.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a perspective view of a braille color-indicating crayon in accordance with an embodiment of the present disclosure.

FIG. 2. is a perspective view of a braille color-indicating colored pencil in accordance with an embodiment of the present disclosure.

FIG. 3 is a perspective view of a braille color-indicating colored marker in accordance with an embodiment of the present disclosure.

FIG. 4 is a cross-sectional view of the braille color-indicating crayon depicted in FIG. 1 taken along line 4-4.

### DETAILED DESCRIPTION

The present disclosure describes a braille color-indicating writing instrument in accordance with an embodiment of the present disclosure. The braille color-indicating writing instrument comprises a body or a shaft that terminates with a tip, including a crayon tip, a pencil tip, or a marker tip, for example. In one embodiment, the crayon, pencil, or marker comprises a blunt end of the writing instrument. In one embodiment wherein the body or shaft is triangular, to keep the writing instrument from rolling, on at least one side of the writing instrument is a recess. Within the recess is a braille identifier that is flush with the surface of the body or shaft. The braille identifier indicates to the blind or visually-impaired individual the color of the crayon, pencil, or marker.

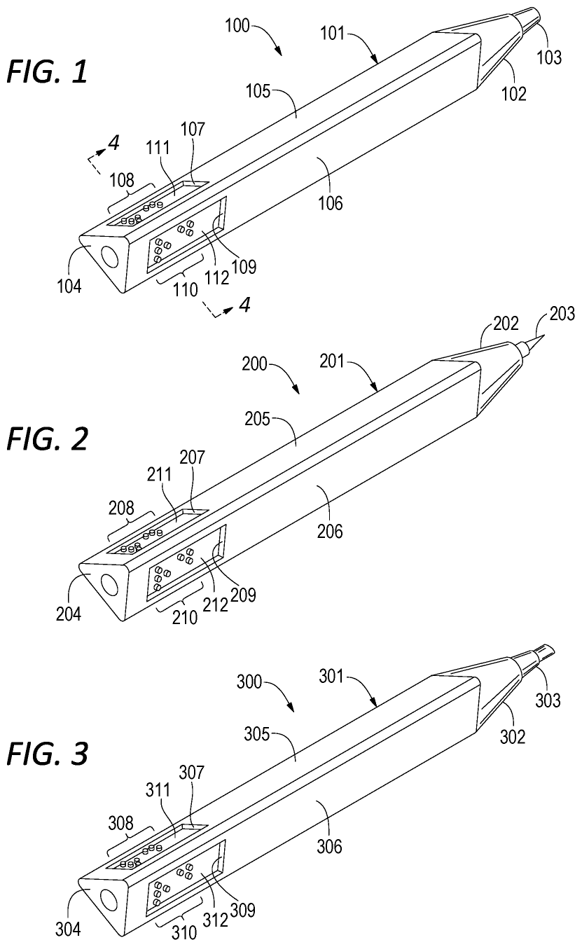

FIG. 1 is a braille color-indicating crayon 100. The braille color-indicating crayon 100 comprises a tip 103, a conical collar 103, a body 101, and the braille color-indicating crayon 100 terminates at a blunt end 104. The tip 103 delivers the color to a writing medium (Not shown), e.g., a piece of paper. In use, an individual (not shown) grasps the body 101, places the tip 103 on the writing medium and colors using the tip 103.

The braille color-indicating crayon 100 has a triangular cross-section. In this regard, the braille color-indicating crayon 100 has three sides, including triangle side 105 and triangle side 106. The third triangle side is not shown in FIG. 1.

In one embodiment, the braille color-indicating crayon 100 comprises a recess 107 on the triangle side 105. The recess 107 is substantially rectangular and comprises a floor 111. Coupled to the floor 111 is a braille color indicator 108. In one embodiment, the braille color indicator 108 comprises a plurality of raised dots that represent an abbreviation of the color of the crayon 100. For example, the [symbol] braille dots are an abbreviation for red, e.g., R and D. In another embodiment, the color may be spelled out in braille, e.g., braille for R-E-D. Note that the abbreviation or the word begins on the blunt end 104 of the crayon 100 and reads up the body 101 toward the tip 103.

In another embodiment, the braille color-indicating crayon 100 comprises a second recess 109 on the triangle side 106. The recess 109 is substantially rectangular and comprises a floor 112. Coupled to the floor 112 is a braille color indicator 110. In one embodiment, the braille color indicator 110 comprises a plurality of raised dots that represent an abbreviation of the color of the crayon 100. For example, the [symbol] braille dots are an abbreviation for red, e.g., R and D. In another embodiment, the color may be spelled out in braille, e.g., braille for R-E-D. Note that the abbreviation or the word begins on the blunt end 104 of the crayon 100 and reads up the body 101 toward the tip 103.

Note that in one embodiment, the braille color indicator 108 comprises a plurality of dots. In such an embodiment, the dots of the braille color indicator 108 may be raised upward until the dots are flush with the triangle side 105. Likewise, the dots of the braille indicator 110 may be raised upward until the dots are flush with the triangle side 106.

FIG. 2 is a braille color-indicating pencil 200. The braille color-indicating pencil 200 comprises a tip 203, a conical collar 202, a body 201, and the braille color-indicating pencil 200 terminates at a blunt end 204. The tip 203 delivers the color to a medium (not shown), e.g., a piece of paper. In use, an individual (not shown) grasps the body 201, places the tip 203 on the writing medium and colors using the tip 203.

The braille color-indicating pencil 200 has a triangular cross-section. In this regard, the braille color-indicating pencil 200 has three sides, including triangle side 205 and triangle side 206. The third triangle side is not shown in FIG. 2.

In one embodiment, the braille color-indicating pencil 200 comprises a recess 207 on the triangle side 205. The recess 207 is substantially rectangular and comprises a floor 211. Coupled to the floor 211 is a braille color indicator 208. In one embodiment, the braille color indicator 208 comprises a plurality of raised dots that represent an abbreviation of the color of the pencil 200. For example, the [symbol] braille dots are an abbreviation for red, e.g., R and D. In another embodiment, the color may be spelled out in braille, e.g., braille for R-E-D. Note that the abbreviation or the word begins on the blunt end 204 of the pencil 200 and reads up the body 201 toward the tip 203.

In another embodiment, the braille color-indicating pencil 200 comprises a second recess 209 on the triangle side 206. The recess 209 is substantially rectangular and comprises a floor 212. Coupled to the floor 212 is a braille color indicator 210. In one embodiment, the braille color indicator 210 comprises a plurality of raised dots that represent an abbreviation of the color of the pencil 200. For example, the [symbol] braille dots are an abbreviation for red, e.g., R and D. In another embodiment, the color may be spelled out in braille, e.g., braille for R-E-D. Note that the abbreviation or the word begins on the blunt end 204 of the pencil 200 and reads up the body 201 toward the tip 203.

Note that in one embodiment, the braille color indicator 208 comprises a plurality of dots. In such an embodiment, the dots of the braille indicator 208 may be raised upward until the dots are flush with the triangle side 205. Likewise, the dots of the braille indicator 210 may be raised upward until the dots are flush with the triangle side 206.

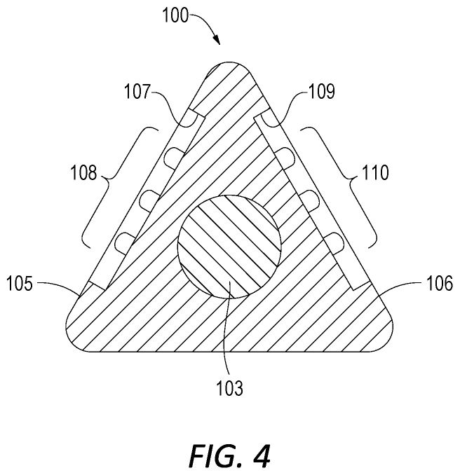

FIG. 3 is a braille color-indicating marker 300. The braille color-indicating marker 300 comprises a tip 303, a conical collar 302, a body 301, and the braille color-indicating marker 300 terminates at a blunt end 304. The tip 303 delivers the color to a medium (not shown), e.g., a piece of paper. In use, an individual (not shown) grasps the body 301, places the tip 303 on the writing medium and colors using the tip 303.

The braille color-indicating marker 300 has a triangular cross-section. In this regard, the braille color-indicating marker 300 has three sides, including triangle side 305 and triangle side 306. The third triangle side is not shown in FIG. 3.

In one embodiment, the braille color-indicating marker 300 comprises a recess 307 on the triangle side 305. The recess 307 is substantially rectangular and comprises a floor 311. Coupled to the floor 311 is a braille color indicator 308. In one embodiment, the braille color indicator 308 comprises a plurality of raised dots that represent an abbreviation of the color of the marker 300. For example, the [symbol] braille dots are an abbreviation for red, e.g., R and D. In another embodiment, the color may be spelled out in braille, e.g., braille for R-E-D. Note that the abbreviation or the word begins on the blunt end 304 of the marker 300 and reads up the body 301 toward the tip 303.

In another embodiment, the braille color-indicating marker 300 comprises a second recess 309 on the triangle side 306. The recess 309 is substantially rectangular and comprises a floor 312. Coupled to the floor 312 is a braille color indicator 310. In one embodiment, the braille color indicator 310 comprises a plurality of raised dots that represent an abbreviation of the color of the marker 300. For example, the [symbol] braille dots are an abbreviation for red, e.g., R and D. In another embodiment, the color may be spelled out in braille, e.g., braille for R-E-D. Note that the abbreviation or the word begins on the blunt end 304 of the marker 300 and reads up the body 310 toward the tip 303.

Note that in one embodiment, the braille color indicator 308 comprises a plurality of dots. In such an embodiment, the dots of the braille indicator 308 may be raised upward until the dots are flush with the triangle side 305. Likewise, the dots of the braille indicator 310 may be raised upward until the dots are flush with the triangle side 306.

FIG. 4 is a cross-sectional view of the crayon 100 taken along line 4-4 of FIG. 1. The pencil 100 comprises a triangular cross-section and the crayon tip 103 runs through the body of the crayon 100.

The cross-sectional view depicted in FIG. 4 comprises the recess 107 on the triangular side 105. The recess 107 comprises the braille color indicator 108. The braille color indicator 108 comprises a plurality of raised dots that indicate a color. In one embodiment, the raised dots are flush with the triangular side 105 of the crayon 100. However, the raised dots may be recessed slightly into the recess 107.

Further, the cross-sectional view depicted in FIG. 4 comprises the recess 109 on the triangular side 106. The recess 109 comprises the braille color indicator 110. The braille color indicator 110 comprises a plurality of raised dots that indicate a color. In one embodiment, the raised dots are flush with the triangular side 106 of the crayon 100. However, the raised dots may be recessed slightly into the recess 107.

In one embodiment, the crayon 100, the pencil 200, and the marker 300 are scented. In this regard, the crayon 100, the pencil 200, and the marker 300 may be infused with a scent that relates to the color of the crayon 100, the pencil 200, and the marker 300. For example, if the crayon 100, the pencil 200, and the marker 300 were the color red, the crayon 100, the pencil 200, and the marker 300 may be infused with a strawberry or raspberry scent.

What is claimed is:

1. A writing instrument, comprising:
a tip for directly contacting and writing on a medium;
a body contiguous with the tip, the body configured for grasping the writing instrument for writing on the medium; and
a first recess on a first side of the writing instrument, the first recess comprising a first braille color indicator comprising a first plurality of raised dots.

2. The writing instrument of claim 1, wherein the first recess is adjacent a blunt end of the writing instrument.

3. The writing instrument of claim 1, wherein a top of the first plurality of raised dots is flush with a surface of the side of the writing instrument.

4. The writing instrument of claim 1, where the writing instrument exhibits a triangular cross-section having the first side, a second side, and a third side.

5. The writing instrument of claim 4, further comprising a second recess on the second side.

6. The writing instrument of claim 5, wherein the second recess comprises a second braille color indicator comprising a plurality of raised dots.

7. The writing instrument of claim 6, wherein the second recess is adjacent a blunt end of the writing instrument.

8. The writing instrument of claim 7, wherein the second recess comprises a second braille color indicator comprising a second plurality of raised dots.

9. The writing instrument of claim 8, wherein a top of the second plurality of raised dots is flush with a surface of the second side of the writing instrument.

10. The writing instrument of claim 1, wherein the writing instrument exhibits a scent.

11. The writing instrument of claim 10, wherein the scent is related to the color of the writing instrument.
